(19) United States
(12) Patent Application Publication
(10) Pub. No.: US 2007/0250688 A1
(43) Pub. Date: Oct. 25, 2007

(54) Simd Type Parallel Arithmetic Device, Processing Element and Control System of Simd Type Parallel Arithmetic Device

(75) Inventor: Shourin Kyou, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/666,895

(22) PCT Filed: Nov. 4, 2005
(86) PCT No.: PCT/JP05/20681

§ 371 Date: Jun. 28, 2007

(30) Foreign Application Priority Data
Nov. 5, 2004 (JP) 2004-322735

(51) Int. Cl. G06F 9/38

(52) U.S. Cl. 712/215

(57) ABSTRACT

An SIMD arithmetic processing device having a processing element based on the VLIW system which is capable of simultaneously executing a plurality of instruction streams by one sequencer, which includes a PE array 109 formed of PE based on the k-way VLIW system capable of simultaneously executing instructions to the maximum of k and one sequencer CP 103 for controlling the array, the CP broadcasting an instruction selection information code X106 other than the number k of instruction codes 104 to each PE. Each VLIW type PE includes a W-bit (W□k) mask register MR 101, an instruction selection circuit SEL 100 for restoring the instruction codes 104 broadcast from the CP to instruction streams to the maximum of k, and an instruction selection control unit SU 102 for generating an instruction selection control signal CX 107 for controlling the instruction selection circuit SEL 100 based on the mask register MR 101 and the instruction selection information code X106.

### FIELD OF THE INVENTION

The present invention relates to an SIMD type parallel arithmetic device and, more particularly, to an SIMD type parallel arithmetic device having a processing element (PE) based on a VLIW (Very Long Instruction Word) system which enables parallel execution of instructions belonging to the same instruction stream, and a control system thereof.

### DESCRIPTION OF THE RELATED ART

With recent advancement of technology, parallel arithmetic devices (hereinafter referred to as parallel processor) having numbers of processing elements (PE) have been put into practical use. As a main control system of a parallel processor, there exist an SIMD (Single Instruction Multiple Data Stream) system and an MIMD (Multiple Instruction Multiple Data Stream) system.

Of these described above, since the SIMD system is structured to have only one circuit block so-called a “sequencer” provided independently of the number of PE which block decodes an instruction code stored in a program memory to transmit a control signal to the PE, the system needs as small as a fraction of (e.g. one-eighth) the circuit scale required for realizing high processing performance as compared with the MIMD system in which each PE has a sequencer to operate in a different instruction stream.

In the SIMD system, because numbers of PE are controlled by a single instruction stream, operation is not autonomous for each PE and high effective performance can be obtained in a case of processing of a type in which the same instruction string is applied to all the data to be processed (data parallel processing), while since as to processing of a type in which a different instruction stream dependent on a data value is applied to each subset of data (region parallel processing) or processing of a type in which different instruction streams are applied in parallel to each other to the same data set (task parallel processing), only the control by a single instruction stream is possible, numbers of PE can not be used effectively, so that high effective performance can not be obtained.

In order to solve the above-described problems, Japanese Patent Laying-Open No. 2001-273268 (Literature 1), for example, discloses a circuit structure of an SIMD type parallel processor in which a flag value or the like of a preceding arithmetic result qualifies operation of a succeeding instruction. Japanese Translation of PCT International Application No. 2001-523023 (Literature 2) discloses a circuit structure of an SIMD type parallel processor in which each PE is provided with a program memory and an instruction decoder to enable a single sequencer to execute dynamic program downloading to each PE and to activate a program having been downloaded.

Furthermore, “D. E. Schimmel: Superscalar SIMD Architecture, Proc. of 4th Symposium on the Frontiers of Massively Parallel Computation, pp. 573-576, 1992” (Literature 3) proposes an SIMD type parallel processor in which a single sequencer broadcasts (transfers) a plurality (e.g. a number k) of instructions to all the PE simultaneously, while each PE selects and executes one from the number k of instructions according to a processing result.

The above-described conventional SIMD type parallel processors have the following problems.

The SIMD type parallel processor disclosed in Literature 1 has shortcomings that the amount of information qualifying operation of an instruction is limited to the order of a bit width of a flag value of an arithmetic result and that because the relevant flag value is defined by an arithmetic result of a preceding instruction, only autonomy of arithmetic operation whose degree of freedom is extremely low can be realized for each PE.

The SIMD type parallel processor disclosed in Literature 2 has shortcomings that the circuit scale is increased equivalently to a program memory in proportional to the number of PE and that an overhead equivalent to a program downloading time is increased in proportional to the number of PE at the time of execution.

Furthermore, the SIMD type parallel processor disclosed in Literature 3 has a shortcoming that because a plurality (e.g. a number k) of instructions are simultaneously broadcast (transferred) to all the PE, a bit width of instruction broadcasting needs to be multiple (e.g. k times), resulting in increasing a circuit scale.

An object of the present invention is to provide an SIMD type parallel processor which realizes instruction stream level parallelism enabling simultaneous execution of a plurality of instruction streams without largely increasing a circuit scale, thereby improving execution performance of a PE array in the SIMD type parallel processor, and a control system thereof.

### SUMMARY OF THE INVENTION

According to this invention for achieving the above-mentioned object, an SIMD type parallel arithmetic device having a very long instruction word type processing element capable of executing instruction codes belonging to the same instruction stream in parallel to each other, wherein parallel-executable instruction codes belonging to a plurality of different instruction streams whose number is not more than the number of parallel-executable instruction codes are selected based on instruction selection information broadcast following said instruction streams and executed by said processing element.

In the preferred construction of this invention, the SIMD type parallel arithmetic device may comprise a sequencer which broadcasts a number k of instruction codes and said instruction selection information to each said processing element, a mask register which stores a value of not less than k bits for designating operation/non-operation of said instruction stream by each said processing element, an instruction selection circuit which restores the number k of instruction codes to different instruction streams to the maximum of k, and an instruction selection control unit which inputs the value of said mask register and said instruction selection information and outputs an instruction selection control signal for controlling said instruction selection circuit.

### BRIEF DESCRIPTION OF THE DRAWINGS

FIG. 1 is a block diagram showing a basic structure of an SIMD type parallel arithmetic device based on the VLIW system;

FIG. 2 is a block diagram showing a structure of an SIMD type parallel arithmetic device which enables parallel execution of four instructions according to a first mode of implementation;

FIG. 3 is a flow chart for use in explaining operation of selecting control information at a selector MX of the SIMD type parallel arithmetic device based on a control information selection signal MC according to the first mode of implementation;

FIG. 4 is a diagram showing an example of four instruction streams broadcast to the SIMD type parallel arithmetic device according to the first mode of implementation with four as k (parallel execution of four instructions);

FIG. 5 is a diagram showing an example of an instruction code string for use in explaining operation of parallel processing of the SIMD type parallel arithmetic device according to the first mode of implementation when the four instruction streams shown in FIG. 4 are broadcast;

FIG. 6 is a diagram for use in explaining contents of control operation by an instruction code string and control information X1˜X4 for explaining operation of parallel processing of the SIMD type parallel arithmetic device according to the first mode of implementation when the four instruction streams shown in FIG. 4 are broadcast;

FIG. 7 is a block diagram showing a structure of an SIMD type parallel arithmetic device enabling parallel execution of four instructions according to a second mode of implementation;

FIG. 8 is a diagram showing an example of four instruction streams broadcast by the SIMD type parallel arithmetic device according to the second mode of implementation with four as k (parallel execution of four instructions);

FIG. 9 is a diagram showing an example of an instruction code string for use in explaining operation of parallel processing of the SIMD type parallel arithmetic device according to the second mode of implementation when the four instruction streams shown in FIG. 8 are broadcast;

FIG. 10 is a diagram for use in explaining contents of control operation by an instruction code string and the control information X1˜X4 for explaining operation of parallel processing of the SIMD type parallel arithmetic device according to the second mode of implementation when the four instruction streams shown in FIG. 8 are broadcast;

FIG. 11 is a block diagram showing a structure of an instruction selection control unit SU of an SIMD type parallel arithmetic device which enables parallel execution of four instructions according to a third mode of implementation;

FIG. 12 is a flow chart for use in explaining operation of a selector DX which selects four bits from a 5-bit mask register MR by using sub control information X10 in the SIMD type parallel arithmetic device which enables parallel execution of four instructions according to the third mode of implementation;

FIG. 13 is a diagram showing control contents of sub control information X11 for controlling four selectors M1˜M4 in the SIMD type parallel arithmetic device which enables parallel execution of four instructions according to the third mode of implementation;

FIG. 14 is a flow chart for use in explaining selection operation of control information based on the control information selection signal MC in a selector MX of the SIMD type parallel arithmetic device according to the third mode of implementation;

FIG. 15 is a diagram showing an example of five instruction streams broadcast by the SIMD type parallel arithmetic device according to the third mode of implementation;

FIG. 16 is a diagram showing contents of conditions for the instruction streams shown in FIG. 15;

FIG. 17 is a diagram showing an example of an instruction code string for use in explaining a result of parallel processing of the SIMD type parallel arithmetic device according to the second mode of implementation in a case where the five instruction streams shown in FIG. 15 are broadcast;

FIG. 18 is a diagram showing an example of an instruction code string for use in explaining a result of parallel processing of the SIMD type parallel arithmetic device according to the third mode of implementation in a case where the five instruction streams shown in FIG. 15 are broadcast; and

FIG. 19 is a diagram for use in explaining contents of control operation by an instruction code string, the control information X10 and the control information X2 to X4 for explaining operation of parallel processing of the SIMD type parallel arithmetic device according to the third mode of implementation in a case where the five instruction streams shown in FIG. 15 are broadcast.

### DESCRIPTION OF THE PREFERRED EMBODIMENT

Next, modes of implementation of the present invention will be described in detail with reference to the drawings.

Reference numerals in the figures will be described in the following.

100: instruction selection circuit SEL, 101: mask register MR, 102: instruction selection control unit SU, 103: sequencer CP, 104: instruction slot S1˜Sk, 106: instruction selection information code X, 107: instruction selection control signal CX, 108: instruction register IR1˜IRk, 109: PE array, 110: PE, 111: instruction decoder D1˜Dk, 112: arithmetic unit E1˜Ek, 113: general-purpose register file REG, 201: selector M1˜M4, 202: control information X1˜X4, 203: selector MX, 204: control information selection signal MC, 401: sub control information X10, 402: sub control information X11, 403: selector DX, 404: decoder DC, 500, 700, 902: instruction string.

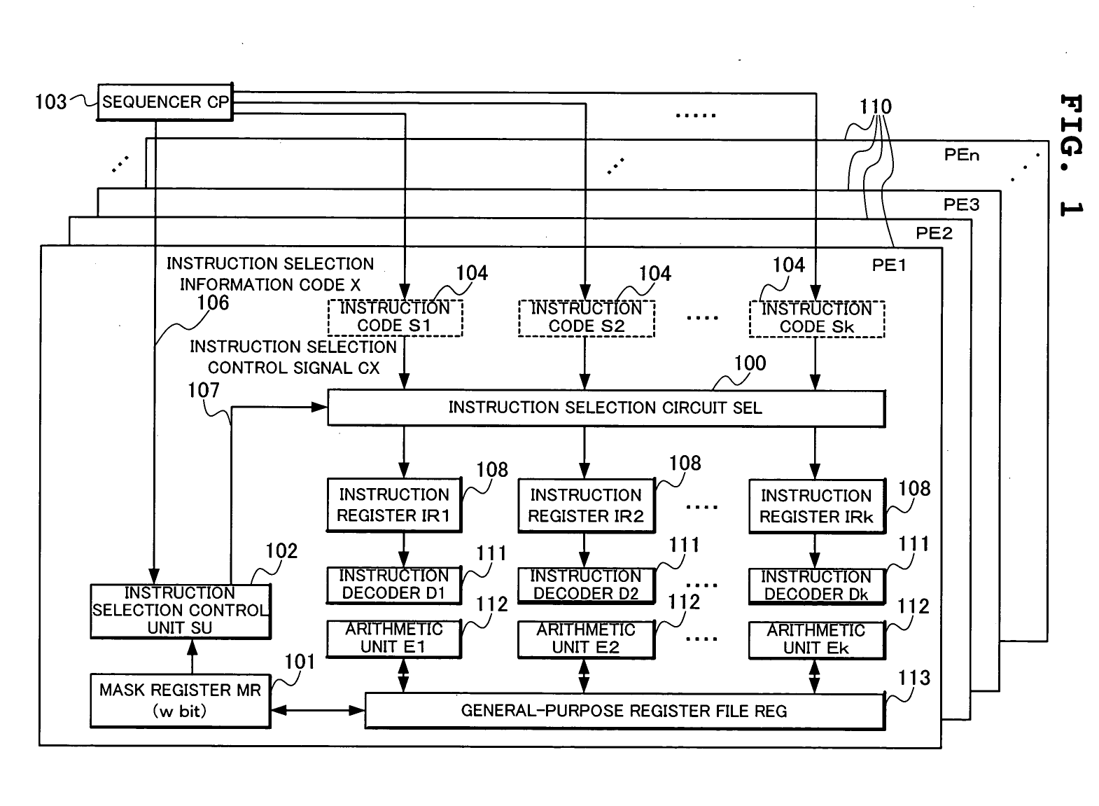

With reference to FIG. 1, an SIMD type parallel arithmetic device based on the VLIW system according to the present invention includes a PE array (109) formed by connecting a number n of PE (110)˜PEn (110) based on a k-way VLIW (Very Long Instruction Word) system which enables simultaneous execution of independent instructions to the maximum of a number k (k: integer not less than two) and one sequencer CP (control processor) (103) for controlling the relevant PE array (109).

The sequencer CP (103) broadcasts an instruction selection information code X (106) to each of the PE (110)˜PEn (110) other than the number k of instruction codes S1˜Sk (104) to each PE.

Each of the VLIW type PE (110)˜PEn (110) includes an instruction selection circuit SEL (100) which selects an instruction (restores the number k of instruction codes to different instruction streams to the maximum of k) before storing the instruction in the number k of instruction registers IR1˜IRk (108) held by the respective PE1 (110)˜PEn (110), a W-bit (W≧k) exclusive (an arbitrary one bit among W bits is 1) mask register MR (101) indicating which of the maximum of W instruction streams should be executed and an instruction selection control unit SU (102) which with the mask register MR (101) and the instruction selection information code X (106) as input, selects a part of the instruction selection information code X (106) based on the value of the mask register MR (101) and outputs the selection as an instruction selection control signal CX (107) for controlling the instruction selection circuit SEL (100).

When there exists instruction stream level parallelism (task level parallelism), the SIMD type parallel arithmetic device having the PE array formed by the VLIW type PE capable of simultaneously executing instructions to the maximum of k uses, for the simultaneous broadcasting of instruction streams to the maximum of k kinds, the instruction codes S1˜Sk (104) which have been empty (NOP) when the number of simultaneously executed instructions existing adjacent to each other in the same instruction stream whose parallel processing is possible fails to reach the number k.

At this time, information necessary for decoding the relevant instruction stream at each of the PE1 (110)˜PEn (110) is simultaneously broadcast to all the PE as the instruction selection information code X (106).

On the PE array 109 side having received broadcasting of the instruction codes S1˜Sk (104) from the sequencer CP (103), the instruction selection control unit SU (102) in each PE cuts out a necessary part from the instruction selection information codes X (106) broadcast from the sequencer CP (103) based on the value of the mask register MR (101) (indicating which instruction stream the relevant PE should execute) which is set based on a data arithmetic result on each PE and uses the part as the instruction selection control signal CX (107) for controlling the instruction selection circuit (100), thereby selecting zero to a number k of instructions from the number k of instruction codes S1˜Sk (104) broadcast from the CP (103) and putting the selected instruction into the instruction register (108) to prepare for execution in subsequent and following clocks.

### Embodiment 1

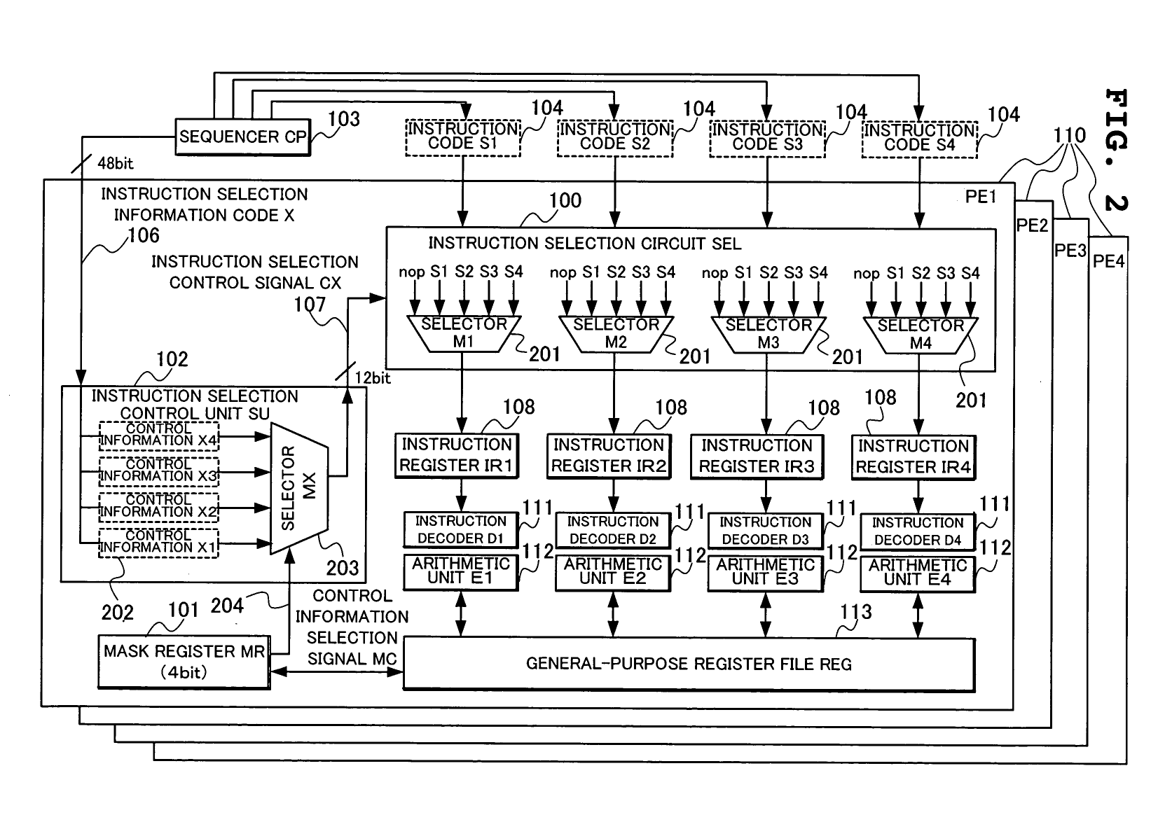

FIG. 2 is a block diagram showing a structure of an SIMD type parallel arithmetic device (processor) based on the VLIW system according to a first mode of implementation of the present invention. For the simplification of explanation, description will be here made of a case where k is four and the number of bits of an instruction code is 32 bits.

In the first mode of implementation, the VLIW type PE array 109 includes four (k) PE1 (110)˜PE4 (110), each of which PE1 (110)˜PE4 (110) includes the instruction selection circuit SEL (100) for selecting an instruction before storing the same in the four instruction registers IR1˜IR4 (108), the four-bit exclusive (an arbitrary one bit among four bits is 1) mask register MR (101) for designating which of the instruction streams to the maximum of four should be executed, and the instruction selection control unit SU (102) for selecting one of the control information X1˜X4 forming the instruction selection information code X (106) broadcast from the sequencer CP (103) based on the value of a control information selection signal MC (204) of the mask register MR (101) to output the result as the instruction selection control signal CX (107) for controlling the instruction selection circuit SEL (100).

In addition, the PE1 (110)˜PE4 (110) include instruction decoders D1 (111)˜D4 (111) for decoding instructions stored in the instruction registers IR1 (108)˜IR4 (108), arithmetic units E1 (112)˜E4 (112) for executing data arithmetic operation by a decoded instruction and a general-purpose register file REG (113) for storing a result of data arithmetic operation.

The instruction selection circuit SEL (100), which is formed of four selectors M1 (201)˜M4 (201) for selecting one of five inputs (selection of k+1→1), is capable of controlling the selectors M1 (201)˜M4 (201) by a control signal of three bits for each selector, that is, 12 bits in total when k is “4”.

Therefore, the sequencer CP (103) broadcasts the instruction selection information code X (106) of 12 bits by 4 (=k) sets, that is, 48 bits to all the PE in addition to the instruction codes S1˜S4 (104) at each instruction processing step.

At each of the PE1 (110)˜PE4 (110), a selector MX (203) in the instruction selection control unit SU (102) selects one of control information X1˜X4 based on the control information selection signal MC (204) and outputs the selected control information as the instruction selection control signal CX (107) to the instruction selection circuit SEL (100).

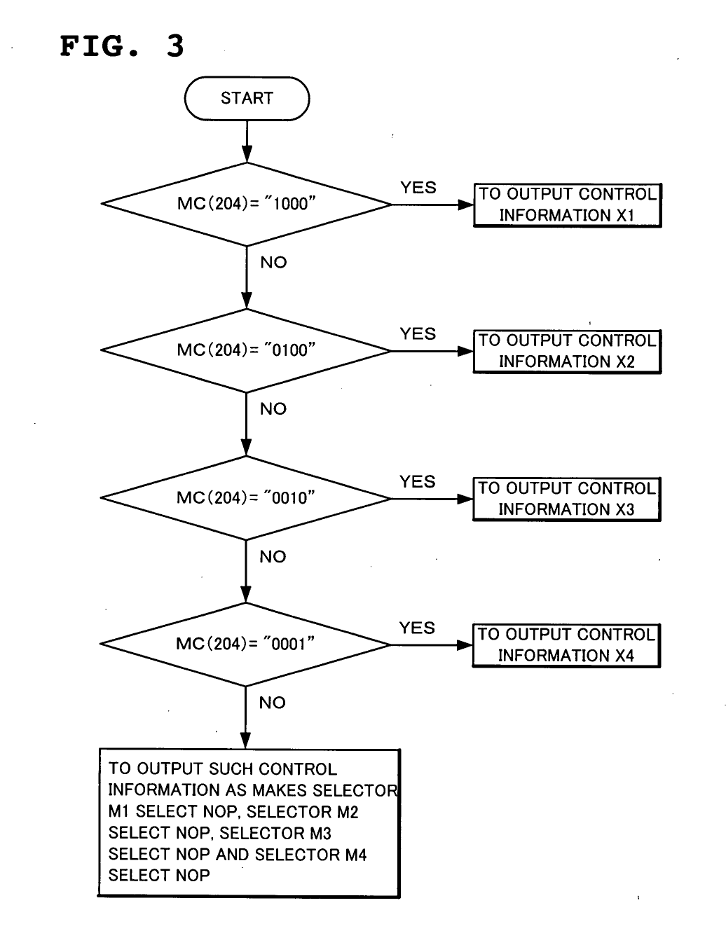

FIG. 3 is a flow chart for use in explaining selection operation of the control information X1˜X4 in the selector MX (203) based on the control information selection signal MC (204).

In FIG. 3, the selector MX (203) outputs, as the instruction selection control signal CX (107), the control information X1 when the control information selection signal MC (204) from the mask register MR (101) is “1000”, the control information X2 when the same is “0100”, the control information X3 when the same is “0010” and the control information X4 when the same is “0001”.

It is also assumed that when the control information selection signal MC (204) has none of the above-described values, control information for making each of the selectors M1 (201)˜M4 (201) select NOP (No Operation) is output as the instruction selection control signal CX (107).

In the above-described first mode of implementation, the number of bits of data to be broadcast to all the PE totals 176 bits including 128 (=32×4) bits related to the instruction codes S1 (104)˜S4 (104) and 48 bits for the instruction selection information code X (106), that is, an increase in the amount of information related to instructions to be broadcast to all the PE by the application of the present invention remains about 38%.

On the other hand, thus structured SIMD type parallel arithmetic device based on the VLIW system according to the first mode of implementation enables different instruction streams to the maximum of four to be processed in parallel. In the following, description will be made of parallel processing of instruction streams in the SIMD type parallel arithmetic device based on the VLIW system according to the first mode of implementation.

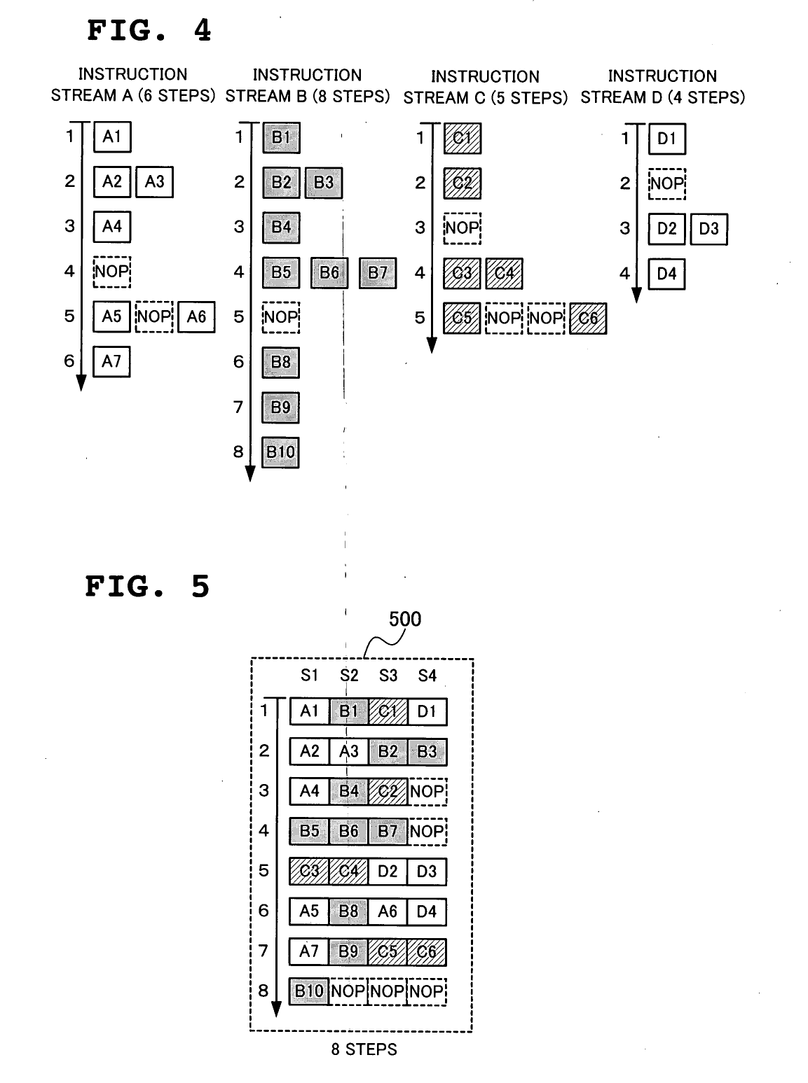

Here, description will be made of a case, as an example, where such an instruction code string of four instruction streams A˜D which can be executed in parallel to each other as shown in FIG. 4 is broadcast.

In a case of FIG. 4, when the respective instruction streams A˜D are executed sequentially, such instruction processing steps are required as six steps for the instruction stream A, eight steps for the instruction stream B, five steps for the instruction stream C and four steps for the instruction stream D, resulting in requiring a total of 23 instruction processing steps.

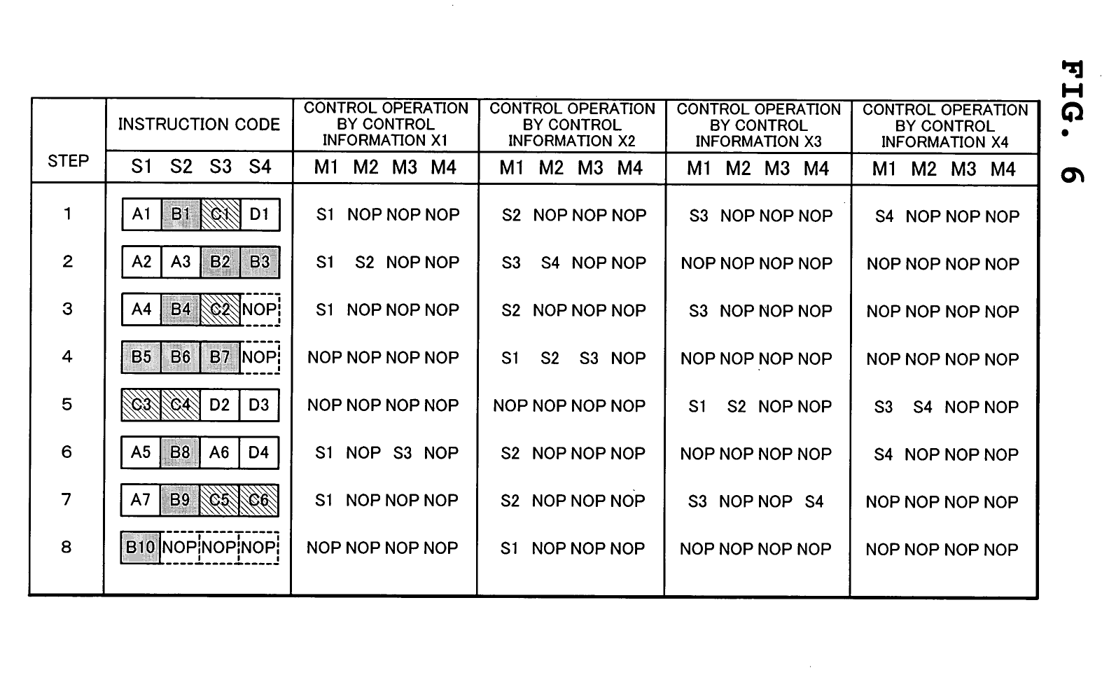

On the other hand, in the SIMD type parallel arithmetic device based on the VLIW system according to the first mode of implementation of the present invention, according to such an instruction string 500 as shown in FIG. 5, broadcasting the instruction codes in each row of the instruction streams A˜D from the sequencer CP (103) to all the PE (PE1˜PE4) at each step and at the same time broadcasting the instruction selection control code X (106) formed of the control information X1˜X4 for controlling operation of the selectors M1 (201)˜M4 (201) as shown in FIG. 6 to all the PE at each step ends the processing of all the instruction streams by eight instruction processing steps. In this case, about 2.9 times faster execution can be realized than that in a case where the respective instruction streams A˜D shown in FIG. 4 are sequentially executed.

As to the four-bit control information selection signal MC (204) set at the mask register MR (101), values are stored in the 0-th bit to the third bit in advance based on such rules as follows.

More specifically, assume that the value of the control information selection signal MC (204) is stored according to the rule that “1” in the first bit (zero in all the other bits) when a certain PE executes the instruction stream A, “1” in the second bit (zero in all the other bits) when the same executes the instruction stream B, “1” in the third bit (zero in all the other bits) when the same executes the instruction stream C, and “1” in the fourth bit (zero in all the other bits) when the same executes the instruction stream D.

The value of the control information selection signal MC (204) is set based on data arithmetic results obtained at the arithmetic units E1˜E4 on each PE.

In addition, the control information X1˜X4 designates the selectors M1˜M4 of the respective PE1 (110)˜PE4 (110) to select instruction codes (S1˜S4) or not.

For example, at Step 1 in FIG. 6, the instruction codes S1, S2, S3 and S4 are selected by the selector M1 of each PE to execute instruction codes A1, B1, C1 and D1 of the respective instruction streams A˜D.

Thus, by assigning the maximum of four instruction streams to each PE by the control information selection signal MC (204) of the mask register MR (101), as well as designating which instruction code is to be selected by which selector of each PE by the control information X1˜X4 corresponding to each PE, such instruction stream parallel processing as shown in FIG. 6 is realized.

As to the selectors M1˜M4 in the instruction selection circuit SEL (100), it is also possible to select the instruction codes S1˜S4 (104) by other selection method than logic for selecting one from five inputs (selection of k+1→1) shown in FIG. 2. It is possible, for example, to make all the selectors M1˜M4 be a selector which makes selection of 2→1. Such structure enables a circuit scale and the number of all the bits of the instruction selection information code X (106) for realizing the instruction selection circuit SEL (100) to be reduced. In this case, however, there is a possibility that constraints on a combination of an instruction string which can be broadcast from the sequencer CP (103) will be increased to deteriorate effective use of the instruction codes S1˜S4 (104) freed.

As described in the foregoing, according to the SIMD type parallel arithmetic device based on the VLIW system in the first mode of implementation, it is possible to use an instruction stream path for k instructions which is originally provided in an SIMD type parallel arithmetic device having a PE array formed by PE based on k-way VLIW system which enables simultaneous execution of instructions to the maximum of k not only for simultaneous execution of instructions which exist adjacent to each other in the same instruction streams and whose parallel processing is possible (called instruction level parallelism) as the original object but also for realizing simultaneous execution of a plurality of instruction streams (instruction stream level parallelism) when instruction level parallelism is in short, thereby improving execution performance of the PE array.

### Second Embodiment

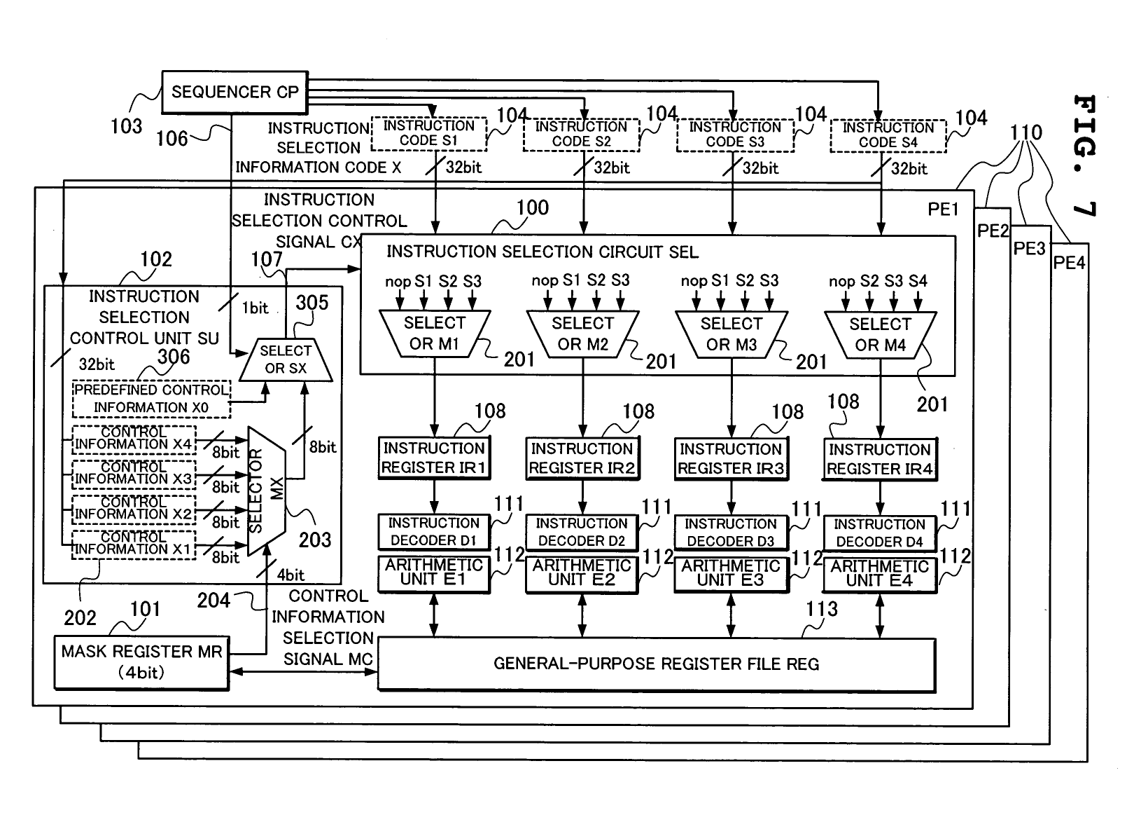

FIG. 7 is a block diagram showing a structure of an SIMD type parallel arithmetic device based on the VLIW system according to a second mode of implementation of the present invention. For the simplification of explanation, assume that k is “4” and the number of bits of the instruction code is 32 bits similarly to the above first mode of implementation.

The second mode of implementation of the present invention differs from the first mode of implementation in that the structure of the selectors M1 (201)˜M4 (201) of the instruction selection circuit SEL (100) is more simplified, that a bit width of the instruction selection information code X (106) is one, that one (the instruction code S4 in FIG. 7) of the instruction codes S1˜S4 (104) is applied to the instruction selection control unit SU (102) and that a new selector SX (305) is provided in the instruction selection control unit SU (102).

In the following, description will be made mainly of the above-described differences from the first mode of implementation.

The instruction selection circuit SEL (100) adopts such selectors M1˜M4 as select one of four inputs (selection of 4→1), which enables control of the selectors M1 (201)˜M4 (201) by a control signal of two bits for each selector, a total of eight bits.

In addition, it is structured such that when in the selector SX (305) additionally provided in the instruction selection control unit SU (102), the value of one-bit instruction selection information code X (106) from the sequencer CP (103) is “0”, predefined control information X0 (306) set in advance is output as the instruction selection control signal CX (107).

The predefined control information X0 (306) is for designating the selector M1 in the instruction selection circuit SEL (100) to select S1, the selector M2 to select S2, the selector M3 to select S3 and the selector M4 to select S4.

When the value of the instruction selection information code X (106) is “1”, the selector SX (305) outputs the control information X1˜X4 selected by the selector MX (203) as the instruction selection control signal CX (107).

Here, for the control information X1˜X4 (202) each having eight bits, a total of 32 bits, which is applied to the selector MX (203), the instruction code S4 is used.

As described in the foregoing, according to the second mode of implementation, in the SIMD type parallel arithmetic device having a PE array based on the four-way VLIW system and having each instruction code (instruction word) formed of 32 bits, only increasing a bit width of information related to an instruction broadcast by the sequencer CP (103) by one bit for the instruction selection control code X (106) enables execution of the maximum of four (=k) of instruction codes which belong to the same instruction stream and can be executed in parallel in a case of operation of a single instruction stream (the value of the instruction selection information code X (106) is “0”) and execution of the maximum of three (=k−1) of instruction codes which belong to the same instruction stream and can be executed in parallel in a case of operation of a plurality of instruction streams (the value of the instruction selection information code X (106) is “1”) by broadcasting the same to the PE array at each instruction processing step.

In the following, description will be made of parallel processing of instruction streams in the SIMD type parallel arithmetic device based on the VLIW system according to the second mode of implementation.

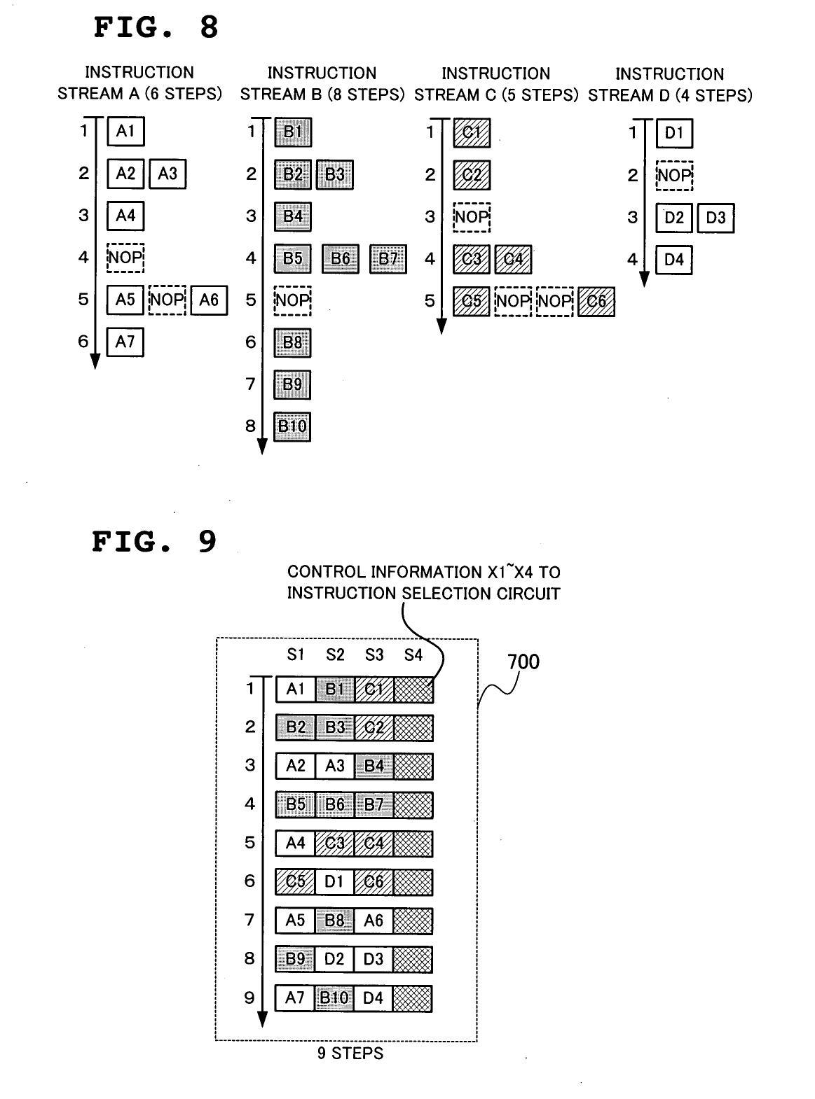

Here, description will be made of parallel processing executed when such an instruction code string of four parallel-executable instruction streams A˜D as shown in FIG. 8 is broadcast as an example.

In a case of broadcasting such an instruction code string of the four instruction streams A˜D as can be executed in parallel to each other as shown in FIG. 8 similar to that in FIG. 4, sequential execution of the respective instruction streams A˜D requires a total of 23 instruction processing steps, which is as described in the first mode of implementation.

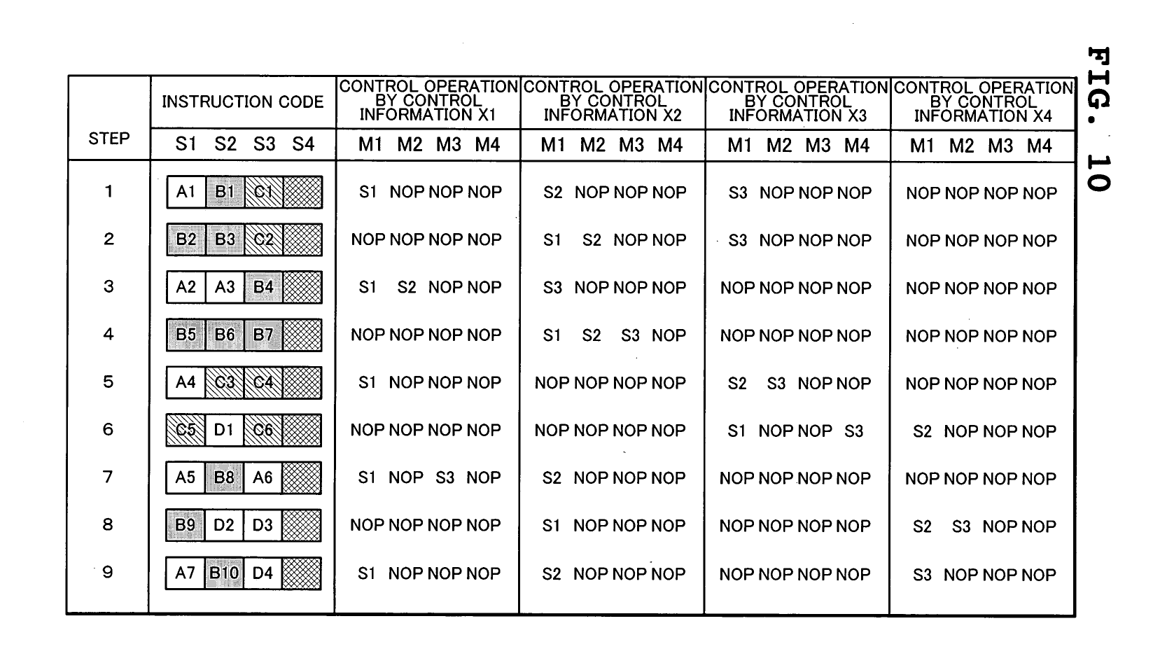

In the SIMD type parallel arithmetic device according to the second mode of implementation, according to such an instruction string (700) as shown in FIG. 9, broadcasting an instruction code in each row from the sequencer CP (103) to all the PE (PE1˜PE4) at each step and at the same time broadcasting the instruction selection control signal X (106) formed of the control information X1˜X4 for controlling selection operation of the selectors M1˜M4 to all the PE by using a pass of the instruction code S4 in a manner shown in FIG. 10 at each step enables processing of all the instruction streams to be completed by nine instruction processing steps.

In this case, about 2.6 times faster execution can be realized than sequential execution of the respective instruction streams A˜D in FIG. 8.

Similarly to the first mode of implementation, however, as to the four-bit control information selection signal MC (204) set in the mask register MR (101), values are stored in its first to fourth bits in advance based on the following rules.

More specifically, assume that the value of the control information selection signal MC (204) is stored according to the rule that “1” in the first bit (zero in all the other bits) when executing the instruction stream A, “1” in the second bit (zero in all the other bits) when executing the instruction stream B, “1” in the third bit (zero in all the other bits) when executing the instruction stream C, “1” in the fourth bit (zero in all the other bits) when executing the instruction stream D.

The value of the control information selection signal MC (204) is set based on data arithmetic results obtained at the arithmetic units E1˜E4 on each PE.

Comparison between hardware costs and effects in the first and second modes of implementation of the present invention finds that while in the first mode of implementation, the number of bits of information to be broadcast from the sequencer CP (103) to all the PE needs to be increased by 48 bits, in the second mode of implementation, it needs to be increased by one bit and information of the one bit only needs to be updated at the switching from execution of a single instruction stream to execution of a plurality of instruction streams or vice versa. Also as to the instruction selection circuit SEL (100), the circuit scale can be made smaller by the second mode of implementation than by the first mode of implementation.

While in the first mode of implementation, the maximum of four instruction streams can be broadcast to all the four PE simultaneously, however, in the second mode of implementation, instruction streams to the maximum of three can be broadcast to the PE simultaneously.

As can be seen from the examples of FIG. 4 to FIG. 6 and FIG. 8 to FIG. 10, for processing the similar four instruction streams A˜D, there is generated a performance difference, for example, eight instruction processing steps when adopting the first mode of implementation and nine instruction processing steps when adopting the second mode of implementation.

Which of the first mode of implementation or the second mode of implementation should be adopted needs to be determined in consideration of a tradeoff between a circuit scale and required performance.

As described in the foregoing, with the SIMD type parallel arithmetic device based on the VLIW system according the second mode of implementation, it is possible to improve execution performance of the PE array, as well as further reducing a circuit scale similarly to the first mode of implementation.

### Third Embodiment

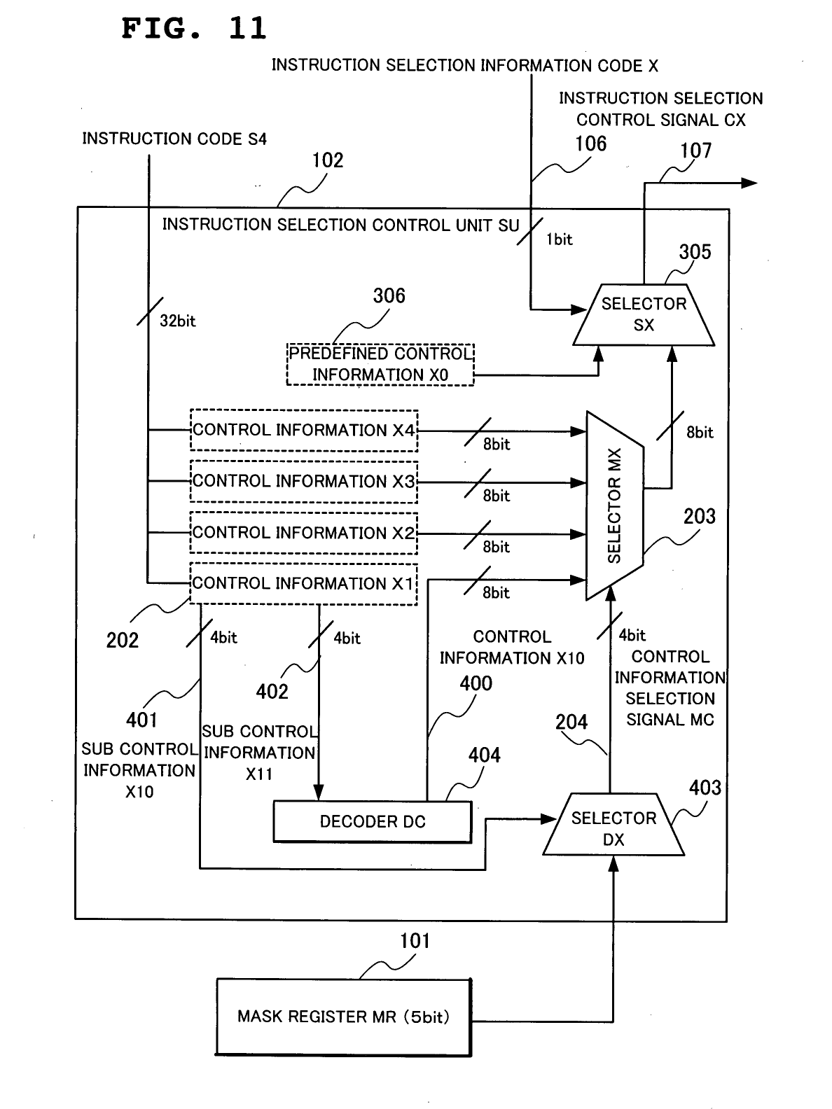

FIG. 11 is a block diagram showing a structure of the instruction selection control unit SU (102) of the SIMD type parallel arithmetic device based on the VLIW system according to the third mode of implementation of the present invention. For the simplification of explanation, assume that k is “4” and the number of bits of the instruction code is 32 bits similarly to the above first and second modes of implementation.

The third mode of implementation of the present invention differs from the second mode of implementation in that the number of bits of the mask register MR (101) can be set to be above k without limiting to the number k (in a case of the present mode of implementation, “4”) of instruction codes which belong to the same instruction stream and can be executed in parallel to each other, that out of the control information X1˜X4 (202) as inputs to the selector MX (203) in the instruction selection control unit SU (102), the contents of the control information X1 (eight bits) are further divided into two groups of four-bit information, sub control information X10 (401) and sub control information X11 (402), to control a newly added selector DX 403 by four bits of the sub control information X10 and select four (=k) bits from a bit string of the mask register MR (101) whose number of bits exceeds four (=k) and that after extending the sub control information X11 (402) to eight bits by using a decoder DC (404), the obtained information is applied to the selector MX (203) in place of the control information X1.

In the third mode of implementation, other structure than that of the instruction selection control unit SU (102) is the same as that of the above-described second mode of implementation.

The selector DX 403 operates to select four (=k) bits from the bit string of the mask register MR (101) whose number of bits exceeds four (=k) by using the four-bit sub control information X10 (401).

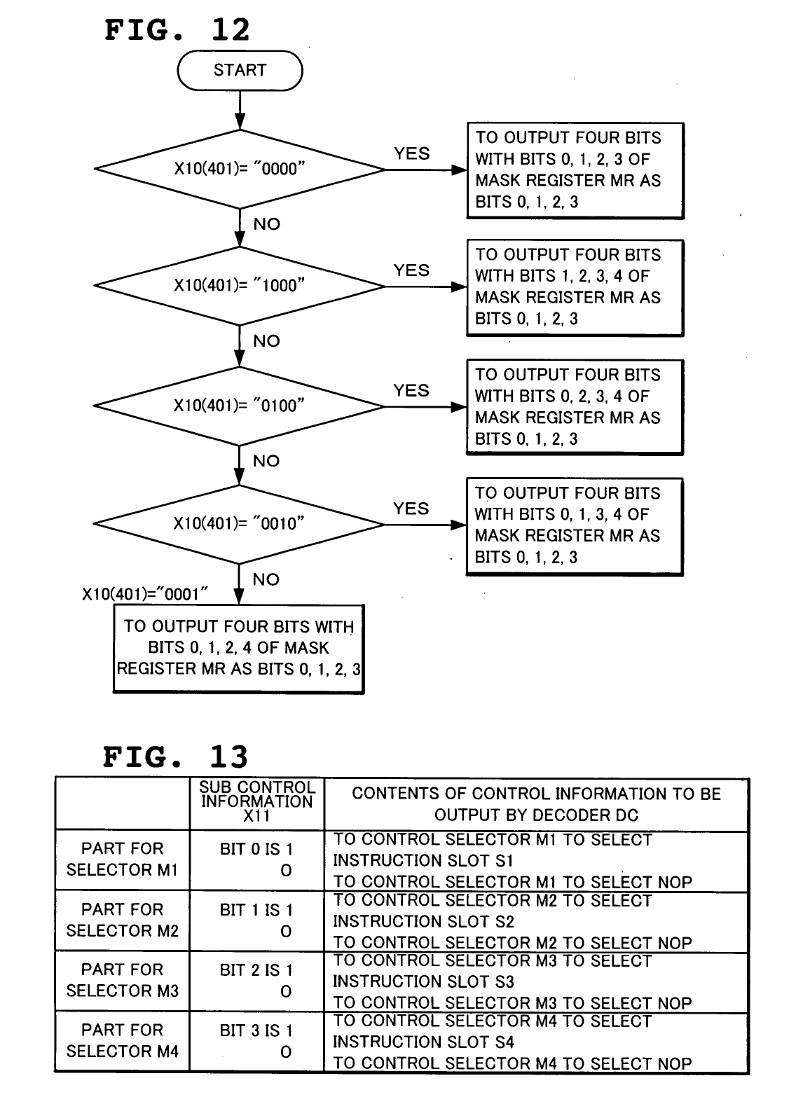

Operation of the selector DX 403 of selecting a total of four (=k) bits from the five-bit mask register MR (101) by using the sub control information X10 (401) is shown in the flow chart in FIG. 12 taking a case where the number of bits of the mask register MR (101) is set to be “5” larger by “1” than k.

In FIG. 12, the selector DX 403, when the four-bit sub control information X10 (401) is “0000”, outputs a bit string with the first, second, third and fourth bits of the mask register MR (101) as its first, second, third and fourth bits, respectively, when the same is “1000”, outputs a bit string with the second, third, fourth and fifth bits of the mask register MR (101) as its first, second, third and fourth bits, respectively, when the same is “0100”, outputs a bit string with the first, third, fourth and fifth bits of the mask register MR (101) as its first, second, third and fourth bits, respectively, and when the same is “0010”, outputs a bit string with the first, second, fourth and fifth bits of the mask register MR (101) as its first, second, third and fourth bits, respectively.

In addition, when the sub control information X10 (401) is “0001”, a bit string with the first, second, fourth and fifth bits of the mask register MR (101) as its first, second, third and fourth bits, respectively.

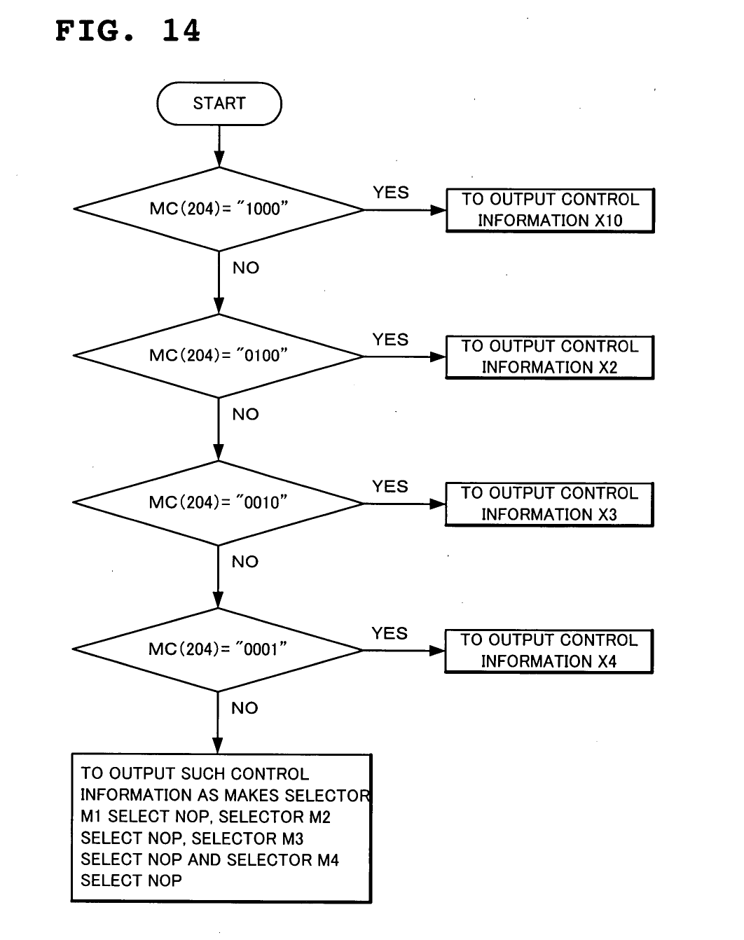

The decoder DC (404) converts the four-bit sub control information X11 (402) into control information X10 (400) which is an eight-bit control signal for controlling the four selectors M1˜M4 (201) and is for executing control contents shown in FIG. 13 and outputs the obtained information.

More specifically, in the example shown in FIG. 13, of the four bits of the sub control information X11 (402), the first bit corresponds to the selector M1, the second bit to the selector M2, the third bit to the selector M3 and the fourth bit to the selector M4, and control is executed such that when the first to fourth bits are “1”, the selectors M1˜M4 select the instruction codes S1˜S4, respectively, and when the same is “0”, the selectors select NOP.

Converting the sub control information X11 (402) by the decoder DC (404) into the eight-bit control information X10 (400) is to have consistency with the number of bits of the control information X2-X4 applied to the selector MX (203) and conversion into eight bits is executed, for example, by padding four bits of “0” to the lower order bits (the fifth bit to eighth bit) of the sub control information X11 (402).

The selector MX (203) selects one from the control information X10 (400) and the control information X2˜X4 (202) based on the control information selection signal MC (204) to output the selection as the instruction selection control signal CX (107) to the instruction selection circuit SEL (100).

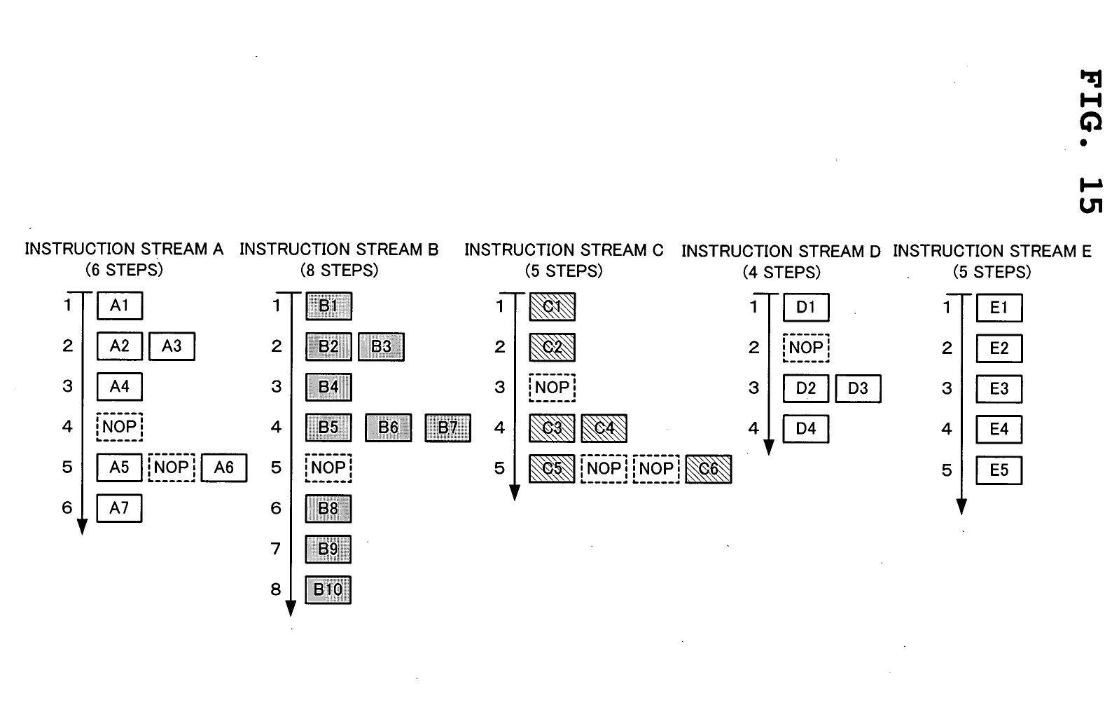

FIG. 14 is a flow chart for use in explaining selection operation of the control information X10 (400) and the control information X2˜X4 based on the control information selection signal MC (204) at the selector MX (203).

In FIG. 14, the selector MX (203) outputs, as the instruction selection control signal CX (107), the control information X10 (400) when the control information selection signal MC (204) from the mask register MR (101) is “1000”, the control information X2 when the same is “0100”, the control information X3 when the same is “0010” and the control information X4 when the same is “0001”.

Also assume that when the control information selection signal MC (204) has none of the above-described values, control information for controlling such that each of the selectors M1 (201)˜M4 (201) selects NOP (No Operation) is output as the instruction selection control signal CX (107).

As compared with the second mode of implementation of the present invention, since the above third mode of implementation of the present invention allows use of the mask register MR (101) having the number of bits larger than the number k of the instruction codes belonging to the same instruction stream which can be executed in parallel to each other as described above, when there exist a larger number of instruction streams which can be executed in parallel to each other, it enables the number of instruction processing steps to be reduced more efficiently.

In the following, the reason will be described together with operation of instruction stream parallel processing in the SIMD type parallel arithmetic device based on the VLIW system according to the third mode of implementation.

Here, description will be made with respect to parallel processing executed when such an instruction code of five instruction streams A˜E which can be executed in parallel to each other as shown in FIG. 15 is broadcast as an example.

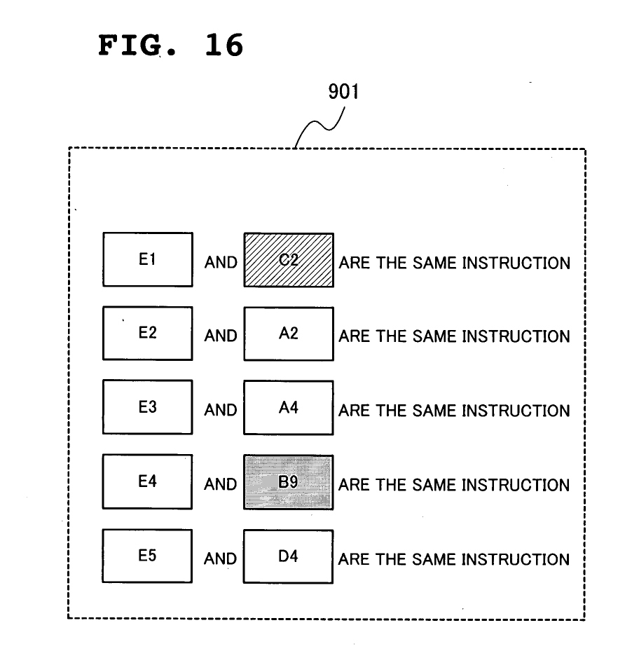

FIG. 15 shows an example where there exists an instruction code string of five instruction streams A˜E which can be executed in parallel to each other and as to the instruction stream E, such conditions as shown in FIG. 16 exist.

When such an instruction code string of five instruction streams A˜E which can be executed in parallel to each other as shown in FIG. 15 is broadcast, sequential execution of the respective instruction streams A˜E requires a total of 28 instruction processing steps.

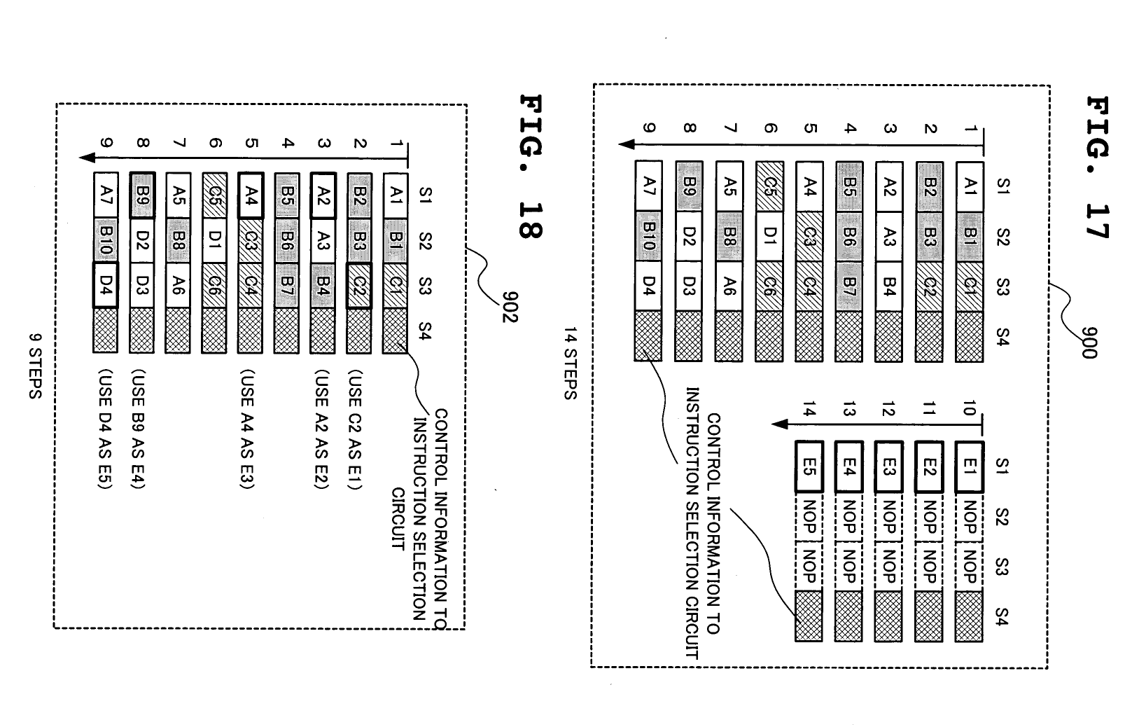

In addition, when using the above second mode of implementation, since the number of bits of the mask register MR (101) is k (=4), instruction streams can be simultaneously executed in parallel to the maximum of four, so that the required number of instruction processing steps totals 14 steps as shown in FIG. 17.

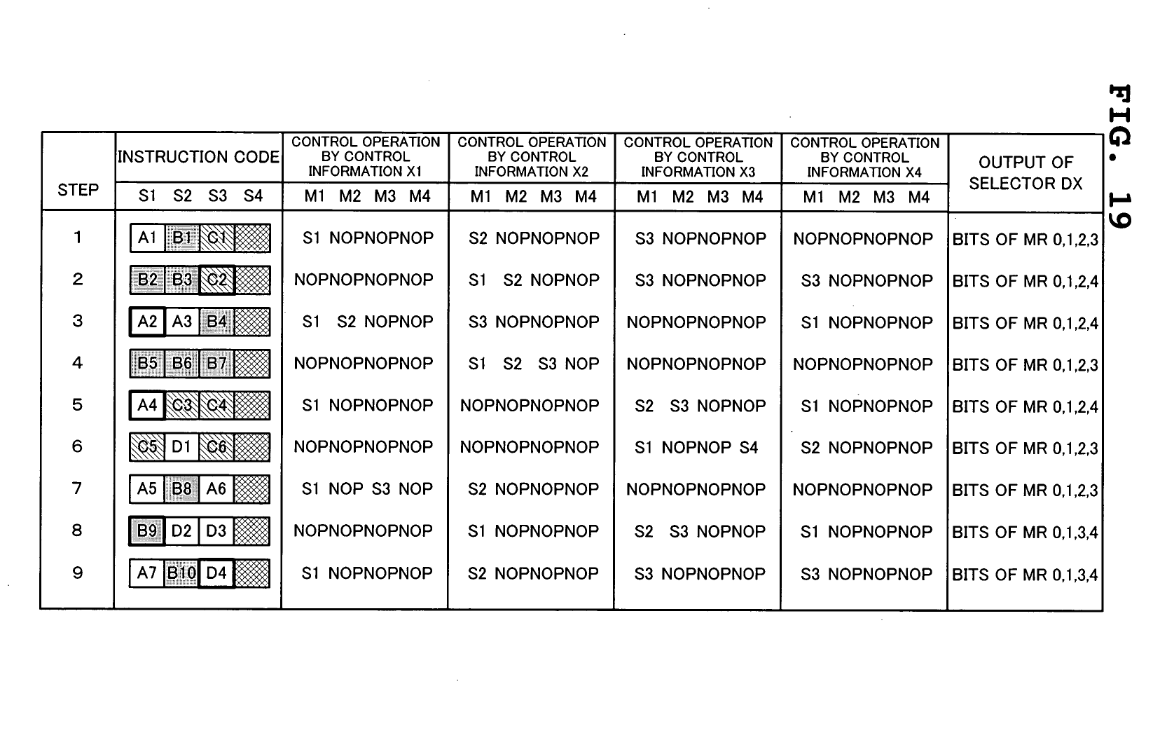

On the other hand, in the SIMD type parallel arithmetic device based on the third mode of implementation, according to such an instruction string (902) as shown in FIG. 18, broadcasting an instruction code of each row to all the PE from the sequencer CP (103) at each step, at the same time broadcasting the instruction selection control signal X (106) formed of the control information X10 (400) and the control information X2˜X4 (202) for controlling selection operation of the selectors M1˜M4 to all the PE at each step as shown in FIG. 19 and controlling the selector DX (403) as shown in FIG. 19 to select four bits from the five-bit mask register MR (101) and supply the selected bits as the control information selection signal MC (204) to the selector MX (203) enables processing of all the five instruction streams to be completed by nine instruction processing steps.

In this case, about 1.6 times faster processing can be realized than the processing using the second mode of implementation.

As to the five-bit control information selection signal MC (204) set at the mask register MR (101), however, the first bit to the fifth bit have values stored in advance based on such rules as follows similarly to the first mode of implementation.

More specifically, assume that the control information selection signal MC (204) has a value stored according to the rule that “1” in the first bit (zero in all the other bits) when executing the instruction stream A, “1” in the second bit (zero in all the other bits) when executing the instruction stream B, “1” in the third bit (zero in all the other bits) when executing the instruction stream C, “1” in the fourth bit (zero in all the other bits) when executing the instruction stream D and “1” in the fifth bit (zero in all the other bits) when executing the instruction stream E.

Thus, according to the third mode of implementation of the present invention, as compared with the second mode of implementation of the present invention, when different instruction streams execute the same instruction at the same instruction processing step, higher-speed processing can be realized.

In particular, when using a compiler which automatically generates an instruction code string from high-level language description, because it is highly probable that the same instruction sequence appears in different instruction streams simultaneously, effectiveness of the third mode of implementation of the present invention is conspicuous.

Although the present invention has been described with respect to a plurality of preferred modes of implementation in the foregoing, the present invention is not necessarily limited to the above-described modes of implantation and it can be modified in various forms within a range of its technical idea.

For example, while in the above first to third modes of implementation, the description has been made with respect to a circuit structure in which k is four and the number of bits of an instruction code is 32, it is apparent that the present invention is applicable also to other structure than those described above as long as k is not less than two.

The present invention enables an SIMD arithmetic processing device having a processing element based on the VLIW system to be realized which is capable of executing a plurality of instruction streams simultaneously by one sequencer.

1. An SIMD type parallel arithmetic device having a very long instruction word type processing element capable of executing instruction codes belonging to the same instruction stream in parallel to each other, wherein
parallel-executable instruction codes belonging to a plurality of different instruction streams whose number is not more than the number of parallel-executable instruction codes are selected based on instruction selection information broadcast following said instruction streams and executed by said processing element.

2. The SIMD type parallel arithmetic device according to claim 1, comprising:
a sequencer which broadcasts a number k of instruction codes and said instruction selection information to each said processing element,
a mask register which stores a value of not less than k bits for designating operation/non-operation of said instruction stream by each said processing element,
an instruction selection circuit which restores the number k of instruction codes to different instruction streams to the maximum of k, and
an instruction selection control unit which inputs the value of said mask register and said instruction selection information and outputs an instruction selection control signal for controlling said instruction selection circuit.

3. The SIMD type parallel arithmetic device according to claim 2, wherein
said instruction selection circuit includes a selector for selecting the number k of said instruction codes, which is formed of the number k of selectors for selecting one from a number k+1 of inputs,
said instruction selection information includes the number k of control information for controlling selection operation of said selector of said instruction selection circuit, and
said instruction selection control unit selects said number k of control information based on the value of said mask register to output the information as said instruction selection control signal to said instruction selection circuit.

4. The SIMD type parallel arithmetic device according to claim 2, wherein
each said processing element switches single instruction stream operation and plural instruction stream operation according to the instruction selection information broadcast by said sequencer, and
said instruction selection control unit outputs a predefined value set in advance as said instruction selection control signal at the time of said single instruction stream operation and inputs one of the number k of instruction codes as said instruction selection information at the time of the plural instruction stream operation.

5. The SIMD type parallel arithmetic device according to claim 4, wherein
said instruction selection circuit includes a selector for selecting a number k−1 of said instruction codes, which is formed of the number k of selectors for selecting one from the number k of inputs,
said instruction selection information includes the number k of control information for controlling selection operation of said selector of said instruction selection circuit, and
said instruction selection control unit outputs a predefined value set in advance as said instruction selection control signal according to a value of one-bit instruction selection information broadcast by said sequencer or selects said number k of control information based on the value of said mask register to output the information as said instruction selection control signal to said instruction selection circuit.

6. The SIMD type parallel arithmetic device according to claim 4 or claim 5, wherein
said instruction selection control unit of each said processing element includes a selector for selecting k bits from said mask register having the number of bits larger than k at the time of said plural instruction stream operation.

7. The SIMD type parallel arithmetic device according to claim 6, wherein one of said control information is divided into two sub control information and one said sub control information is decoded and used as relevant control information, while other said sub control information is used for controlling said selector to select k bits from said mask register.

8. A control method of an SIMD type parallel arithmetic device having a very long instruction word type processing element capable of executing instruction codes belonging to the same instruction stream in parallel to each other, comprising the steps of:
selecting parallel-executable instruction codes belonging to a plurality of different instruction streams whose number is not more than the number of parallel-executable instruction codes based on instruction selection information broadcast following said instruction streams, and
executing said selected instruction code by said processing element.

9. The control method according to claim 8, comprising the steps of:
broadcasting a number k of instruction codes and said instruction selection information to each said processing element, and
inputting a value of a mask register which stores a value of not less than k bits for designating operation/non-operation of said instruction stream by each said processing element and said instruction selection information and outputting an instruction selection control signal for controlling an instruction selection circuit which restores the number k of instruction codes to different instruction streams to the maximum of k.

10. The control method according to claim 9, wherein
said instruction selection circuit includes a selector for selecting the number k of said instruction codes, which is formed of the number k of selectors for selecting one from a number k+1 of inputs, and
said instruction selection information includes the number k of control information for controlling selection operation of said selector of said instruction selection circuit, and which comprises the step of:
selecting said number k of control information based on the value of said mask register to output the information as said instruction selection control signal to said instruction selection circuit.

11. The control method according to claim 9, wherein
each said processing element switches single instruction stream operation and plural instruction stream operation according to the instruction selection information broadcast by said sequencer, and
a predefined value set in advance is output as said instruction selection control signal at the time of said single instruction stream operation and one of the number k of instruction codes is input as said instruction selection information at the time of the plural instruction stream operation.

12. The control method according to claim 11, wherein
said instruction selection circuit includes a selector for selecting a number k−1 of said instruction codes, which is formed of the number k of selectors for selecting one from the number k of inputs, and said instruction selection information includes the number k of control information for controlling selection operation of said selector of said instruction selection circuit, and
a predefined value set in advance is output as said instruction selection control signal according to a value of one-bit instruction selection information broadcast by said sequencer or said number k of control information is selected based on the value of said mask register and output as said instruction selection control signal to said instruction selection circuit.

13. The control method according to claim 11 or claim 12, wherein k bits are selected from said mask register having the number of bits larger than k at the time of said plural instruction stream operation.

14. The control method according to claim 13, wherein one of said control information is divided into two sub control information and one said sub control information is decoded and used as relevant control information, while other said sub control information is used for controlling said selector to select k bits from said mask register.

15. A very long instruction word type processing element which forms an SIMD type parallel arithmetic device and is capable of executing instruction codes belonging to the same instruction stream in parallel to each other, wherein
parallel-executable instruction codes belonging to a plurality of different instruction streams whose number is not more than the number of parallel-executable instruction codes are selected and executed based on instruction selection information broadcast following said instruction streams.

16. The processing element according to claim 15, which
receives input of a number k of instruction codes and said instruction selection information broadcast by a sequencer, comprising:
a mask register which stores a value of not less than k bits for designating operation/non-operation of said instruction stream,
an instruction selection circuit which restores the number k of instruction codes to different instruction streams to the maximum of k, and
an instruction selection control unit which inputs the value of said mask register and said instruction selection information and outputs an instruction selection control signal for controlling said instruction selection circuit.

17. The processing element according to claim 16, wherein
said instruction selection circuit includes a selector for selecting the number k of said instruction codes, which is formed of the number k of selectors for selecting one from a number k+1 of inputs,
said instruction selection information includes the number k of control information for controlling selection operation of said selector of said instruction selection circuit, and
said instruction selection control unit selects said number k of control information based on the value of said mask register to output the information as said instruction selection control signal to said instruction selection circuit.

18. The processing element according to claim 16, which
switches single instruction stream operation and plural instruction stream operation according to the instruction selection information broadcast by said sequencer, and
said instruction selection control unit outputs a predefined value set in advance as said instruction selection control signal at the time of said single instruction stream operation and inputs one of the number k of instruction codes as said instruction selection information at the time of the plural instruction stream operation.

19. The processing element according to claim 18, wherein
said instruction selection circuit includes a selector for selecting a number k−1 of said instruction codes, which is formed of the number k of selectors for selecting one from the number k of inputs,
said instruction selection information includes the number k of control information for controlling selection operation of said selector of said instruction selection circuit, and
said instruction selection control unit outputs a predefined value set in advance as said instruction selection control signal according to a value of one-bit instruction selection information broadcast by said sequencer or selects said number k of control information based on the value of said mask register to output the information as said instruction selection control signal to said instruction selection circuit.

20. The processing element according to claim 18 or claim 19, wherein
said instruction selection control unit includes a selector for selecting k bits from said mask register having the number of bits larger than k at the time of said plural instruction stream operation.

21. The processing element according to claim 20, wherein one of said control information is divided into two sub control information and one said sub control information is decoded and used as relevant control information, while other said sub control information is used for controlling said selector to select k bits from said mask register.
